(19) United States
(12) Patent Application Publication
(10) Pub. No.: US 2008/0154983 A1
(43) Pub. Date: Jun. 26, 2008

(54) INTERFACE APPARATUS AND METHOD FOR MANAGING FILE VERSIONS

(75) Inventors: CHUNG-I LEE, Tu-Cheng (TW); CHIEN-FA YEH, Tu-Cheng (TW); DA-PENG LI, Shenzhen (CN); ZHI-HONG LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/942,721

(22) Filed: Nov. 20, 2007

(30) Foreign Application Priority Data
Dec. 20, 2006 (CN) 200610157700.7

(51) Int. Cl. G06F 17/30

(52) U.S. Cl. 707/203; 707/E17.01

(57) ABSTRACT

A method for managing file versions of files via an interface apparatus includes: submitting a request for a file via a Web page to the interface apparatus, the request including: an uploading request, a downloading request, or a viewing request; managing the file via the interface apparatus, the managing including: uploading the file and the interface apparatus storing the file in a versions control server, or the interface apparatus downloading the file from the version control server, or the interface apparatus downloading a modification log of the file from the versions control server to view. The interface apparatus is installed on a Web server and is connected with the versions control server. The interface apparatus includes a service layer, a file control layer, and a client layer. The interface apparatus for managing file versions is also disclosed.

### BACKGROUND OF THE INVENTION

1. Field of the Invention

The present invention relates to an interface apparatus and method for managing file versions.

2. Description of Related Art

Versions control systems allow managing file modifications by an author or a group of developers of the file. However, at the present time, the versions control systems manages the versions of files via client program, run independently, and cannot be integrated with other systems.

What is needed, therefore, is an interface apparatus and method for managing file versions that overcomes the above mentioned deficiencies.

### SUMMARY OF THE INVENTION

An interface apparatus for managing file versions of files is installed on a Web server and is connected with a versions control server which stores the files. The interface apparatus is configured for receiving a request for a file via a Web page. The request includes: an uploading request, a downloading request, or a viewing request. The interface apparatus is further configured for managing the file versions. The managing includes: uploading the file in the versions control server, downloading the file from the version control server, or downloading a modification log of the file from the versions control server to view.

A method for managing file versions of files via an interface apparatus includes: submitting a request for a file via a Web page to the interface apparatus, the request including: an uploading request, a downloading request, or a viewing request; managing the file versions via the interface apparatus, the managing including: uploading the file and the interface apparatus storing the file in a versions control server which stores the files, the interface apparatus downloading the file from the version control server, or the interface apparatus downloading a modification log of the file from the versions control server to view. The interface apparatus is installed on a Web server and includes a service layer, a file control layer, and a client layer. The interface apparatus is connected with the versions control server via the client layer.

### BRIEF DESCRIPTION OF THE DRAWINGS

FIG. 1 is a schematic diagram of hardware configuration of an interface apparatus for managing file versions in accordance with a preferred embodiment;

FIG. 2 is a diagram of a relation of a modification log, a control record, and a file of the preferred embodiment;

FIG. 3 is a flowchart of a preferred method for managing file versions via an interface apparatus in accordance with a preferred embodiment;

FIG. 4 is a flowchart of uploading a file via an interface apparatus in accordance with a preferred embodiment;

FIG. 5 is a flowchart of downloading a file via an interface apparatus in accordance with a preferred embodiment;

FIG. 6 is a flowchart of viewing a modification log of a file via an interface apparatus in accordance with a preferred embodiment.

### DETAILED DESCRIPTION OF THE INVENTION

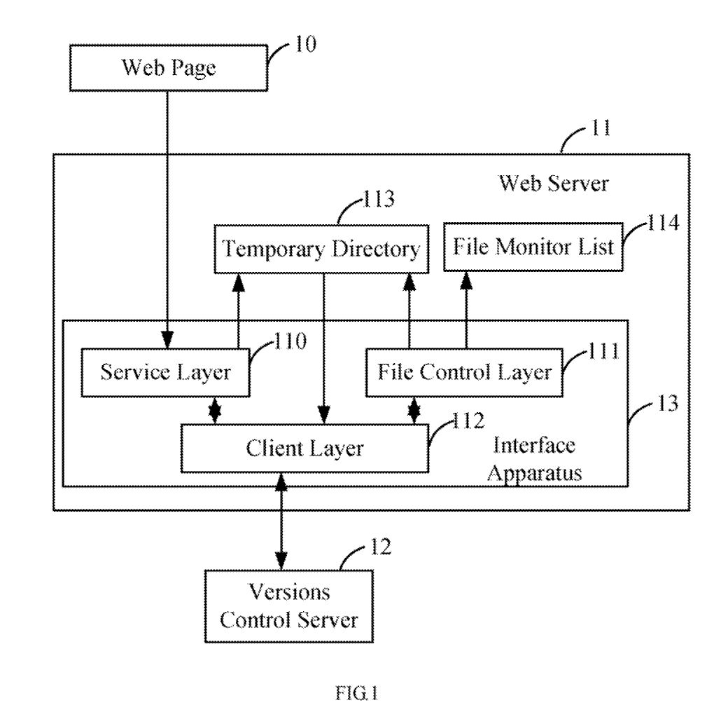

FIG. 1 is a schematic diagram of hardware configuration of an interface apparatus for managing file versions in accordance with a preferred embodiment. The interface apparatus 13 is installed on a Web server 11. The interface apparatus 13 includes a service layer 110, a file control layer 111, and a client layer 112. The interface apparatus 13 connects with the versions control server 12 via the client layer 112.

The file control layer 111 is configured for creating a temporary directory 113 on the Web server 11 to temporarily store a copy of a file to be transferred.

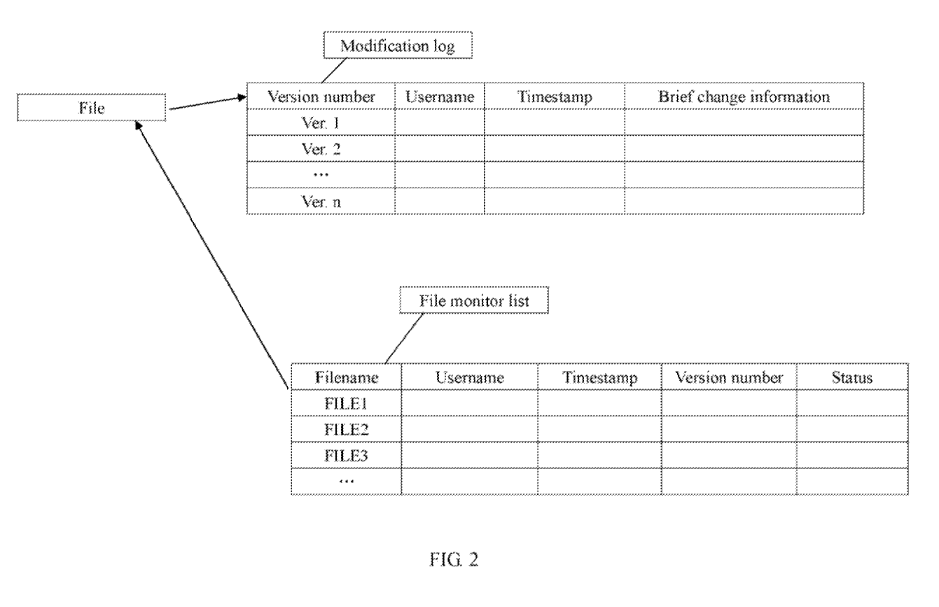

The file control layer 111 is configured for creating a file monitor list 114 in the Web server 11. The file monitor list 114 lists all the files in the versions control server 12. The file control layer 11 is configured for creating a new entry for a new file in the file monitor list 114 and the file control layer 111 is also configured for creating a new modification log for the new file in the versions control server 12. A diagram depicting relationships between the modification log, the file monitor list 114, and the file is illustrated in FIG. 2. As shown in this figure, each of the files corresponds to a modification log. The modification log includes a plurality of entries. In an entry in the modification log consists a version number field, a username field, a timestamp field, and a brief change information field. In addition, each of the files corresponds to an entry in the file monitor list 114. Each entry in the file monitor list 114 includes: a filename field, a username field, a timestamp field, a version number field, and a status field. The filename field stores the name of the file. The username field identifies who made modifications to each version of the file. The timestamp field specifies a timestamp of the modification of the file. The version number field stores the version number (or version name) of the modification of the file. The status field shows if the file is “locked” (being modified) or “unlocked” (not being modified). If the file is being modified or is to be modified by the user, the status field of the file is “locked” and someone else views only the file.

The service layer 110 is configured for receiving requests from a user via a Web page 10. The requests include an uploading request, a downloading request, and a viewing request.

The uploading request includes: the file, the username, and the brief change information (BCI). The file of the uploading request may be a new file (a new file request) or a new file version (a new file version request). The brief change information is a brief description to modifications of the file and is written by the user. The downloading request includes: a filename and a file access request. The file access request includes: read only request or modify request. The read only request represents that the user reads only the file to be downloaded. The modify request represents that the user reads and modifies the file to be downloaded. The file of the downloading request may be a latest file version (a latest file version request) or a previous file version (a previous file version request). The viewing request includes the filename.

The service layer 110 is configured for determining whether it is receiving the new file request or the new file version request.

The service layer 110 is also configured for storing the new file or the new file version in the temporary directory 113.

The client layer 112 is configured for determining whether the file status is “locked” or “unlocked” according to the status field of the file if the service layer 110 receives the new file version request. The client layer 112 is configured for obtaining the new file version from the temporary directory 113 and transferring the new file version to the versions control server 12 if the file status is “unlocked”.

The client layer 112 is configured for obtaining the new file from the temporary directory 113 and transferring the new file to the versions control server 12 if the service layer 110 is receiving the new file request. The client layer 112 is further configured for instructing the file control layer 111 to modify the status field of the file to “unlocked” after client layer 112 transfers the new file or the new file version to the versions control server 12.

The file control layer 111 is configured for updating the username field, the timestamp field, the version number field, and the status field of the file in the file monitor list 114 with the username, the timestamp, and the new file version number correspondingly if the uploading request is the new file version and for inserting a new entry into the modification log of the file. The new entry includes: the new file version number, the username, the timestamp, and the brief change information (BCI).

The service layer 110 is further configured for determining whether it is receiving the latest file version request or the previous file version request.

The client layer 112 is configured for determining whether the latest file version is to be modified according to the file access request if the service layer 110 is receiving the latest file version request. The client layer 112 is configured for instructing the file control layer 111 to modify the status field of the file to “locked” if the latest file version is to be modified.

The client layer 112 is configured for obtaining the latest file version from the versions control server 12 according to the filename and the latest file version number if the service layer 110 is receiving the latest file version request and storing the latest file version to the temporary directory 113.

The client layer 112 is also configured for obtaining the previous file version from the versions control server 12 according to the filename, the latest file version number, and the previous file version number if the service layer 110 is receiving the previous file version request and storing the previous file version to the temporary directory 113.

The service layer 110 is also configured for reading the latest file version or the previous file version into the object HttpResponse of HTTP protocol from the temporary directory 113. The client layer 112 is also configured for removing the latest file version or the previous file version from the temporary directory 113.

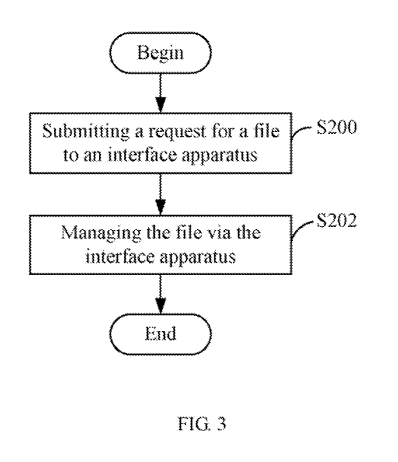

FIG. 3 is a flowchart of a preferred method for managing file versions via an interface apparatus in accordance with a preferred embodiment. In step S200, a user submits the request for a file via the Web page 10 to the interface apparatus 13. The request includes: an uploading request, a downloading request, or a viewing request. The uploading request includes: the file, the username, and the brief change information. The file of the uploading request may be a new file (a new file request) or a new file version (a new file version request). The downloading request includes: the filename and the file access request. The file of the downloading request may be the latest file version (the latest file version request) or the previous file version (the previous file version request). The file access request includes: read only request or modify request. The viewing request includes the filename.

In step S202, the user manages the file via the interface apparatus 13. That is to say, the user uploads the file via the Web page 10 and the interface apparatus 13 stores the file in the versions control server 12; or the interface apparatus 13 downloads the file from the version control server 12 and sends the file to the Web page 10; or the interface apparatus 13 downloads the modification log of the file from the versions control server 12.

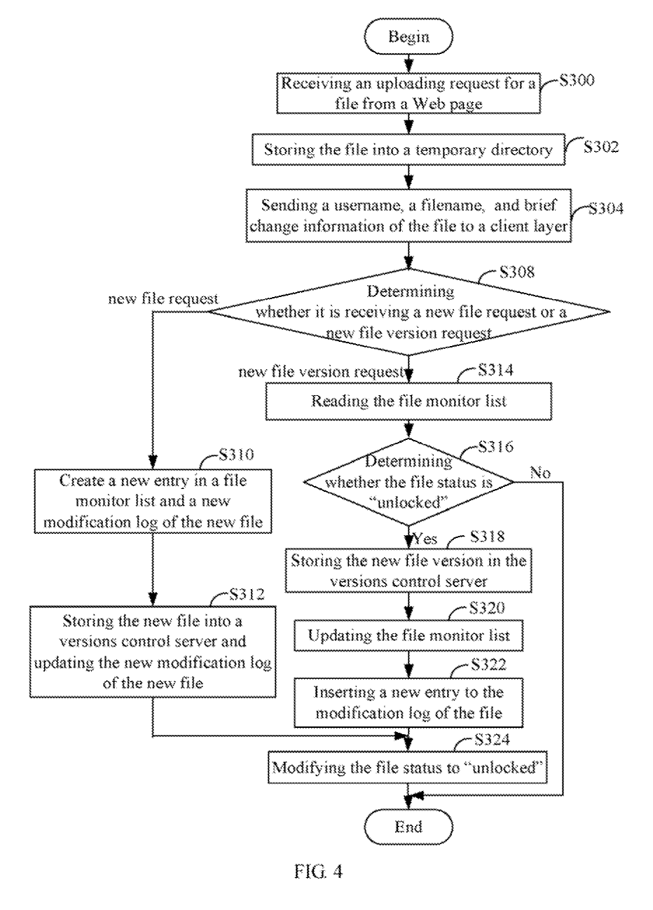

FIG. 4 is a flowchart of uploading a file via an interface apparatus in accordance with a preferred embodiment. In step S300, the service layer 110 receives the uploading request for the file via the Web page 10 and sends the uploading request to the client layer 112. The uploading request includes: the file, the username, and the brief change information. The file of the uploading request may be the new file (the new file request) or the new file version (the new file version request). In step S302, the service layer 110 stores the file in the temporary directory 113. In step S304, the service layer 110 sends<sends/forwards/transfers/saves> the username, the filename, and the brief change information of the file to the client layer 112. The brief change information is the brief description to modifications of the file and is written by the user.

In step S308, the service layer 110 determines whether it is receiving the new file request or the new file version request. If it is receiving the new file version request, the procedure goes directly to step S314 described below.

If it is receiving the new file request, in step S310, the file control layer 111 creates a new entry in the file monitor list 114 for the new file in the Web server 11 and the client layer 112 creates a new modification log for the new file in the versions control sever 12. The new entry in the file monitor list 114 includes: the filename field, the username field, the timestamp field, and the version number field. The new entry also includes a status field that shows if the file status is “locked” (being modified) or “unlocked” (not being modified). The modification log includes a plurality entries; each entry includes: the version number field, the username field, the timestamp field, and the brief change information field corresponding to each of the modifications of the file. By default, if the file is a newly created file, the version number field is 1, the brief change information field is blank.

In step S312, the client layer 112 obtains the new file from the temporary directory 113 and stores the new file in the versions control server 12. The client layer 112 stores the filename, the username of the uploading request, the timestamp, and the version number to the new entry in the file monitor list 114, and updates the version number field, username field, and the timestamp field of the modification log of the new file with the contents of the new entry.

If it is receiving the new file version request, in step S314, the client layer 112 instructs the file control layer 111 to reads the entry of the file in the file monitor list 114. The entry of the file contains the status field. The status field shows if the file is “locked” or “unlocked”.

In step S316, the client layer 112 determines whether the file status of the file is “locked” or “unlocked” according to the status field. If the file is “locked”, the new file version is forbidden to be uploaded, the procedure ends.

If the file is “unlocked”, in step S318, the client layer 112 obtain the new file version from the temporary directory 113 and stores the new file version in the versions control server 12.

In step S320, the client layer 112 instructs the file control layer 111 to update the username field, the timestamp field, and the version number field of the file in the file monitor list with the username, the timestamp, and the current version number correspondingly.

In step S322, the client layer 112 inserts a new entry into the modification log of the file and stores the new file version number, the username, the timestamp, and the brief change information of the new file version to the new entry.

In step S324, the client layer 112 instructs the file control layer 111 to modify the status field of the file in the file monitor list 114 to “unlocked”.

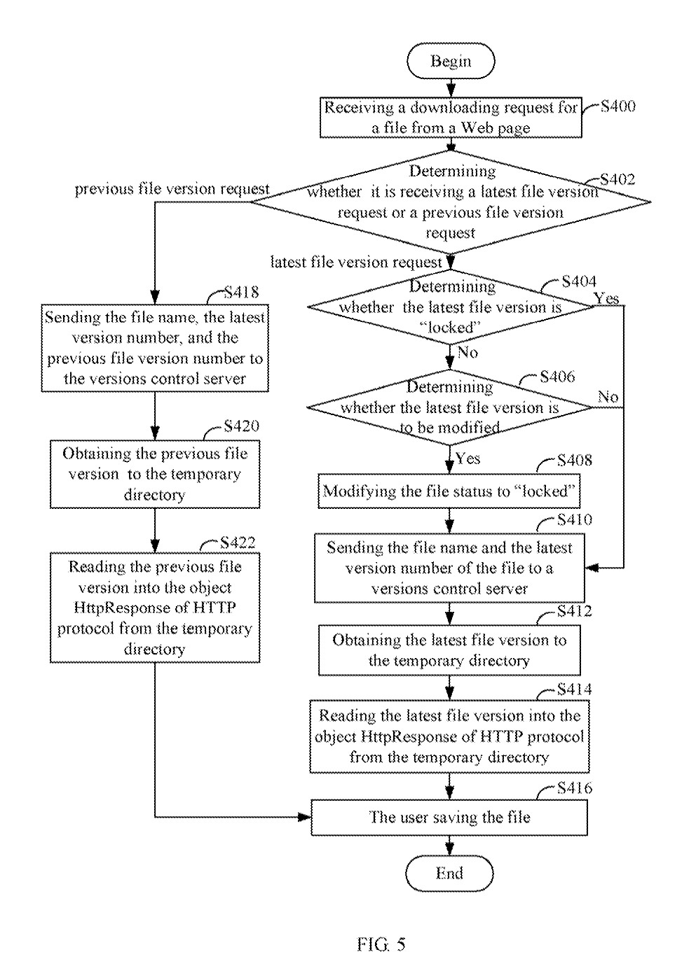

FIG. 5 is a flowchart of downloading a file via an interface apparatus in accordance with a preferred embodiment. In step S400, the service layer 110 receives the downloading request for a file from a user via the Web page 10, sends the downloading request to the client layer 112, and the client layer 112 instructs the file control layer 111 reads the file monitor list 114 according to the downloading request. The downloading request includes: the filename and the file access request. The file access request includes: read only request and modify request. The file of the downloading request may be the latest file version (the latest file version request) or the previous file version (the previous file version request).

In step S402, the service layer 110 determines whether it is receiving the latest file version request or the previous file version request. If it is receiving the previous file version request, the procedure goes directly to step S418 described below.

If it is receiving the latest file version request, in step S404, the client layer 112 determines whether the latest file version is “locked” according to the status field of the file in the file monitor list 114. If the latest file version is “locked”, the procedure goes directly to step S410 described below.

If the latest file version is “unlocked”, in step S406, the client layer 112 determines whether the latest file version is to be modified by the user according to the file access request.

If the latest file version is not to be modified, the procedure goes directly to step S410 described below.

If the latest file version is to be modified, in step S408, the client layer 112 instructs the file control layer 111 to modify the status field to “locked”.

In step S410, the client layer 112 sends the filename and the latest file version number to the versions control server 12. The versions control server 12 yields the latest file version according to the latest file version number.

In step S412, the client layer 112 obtains the latest file version from the versions control server 12 and stores the latest file version in the temporary directory 113.

In step S414, the service layer 110 reads the latest file version into the object HttpResponse of HTTP protocol from the temporary directory 113. The client layer 12 removes the latest file version from the temporary directory 113 after the service layer 110 reads the latest file version.

In step S416, the user reads the latest file version via the Web page 10 and saves the latest file version.

In step S418, the service layer 110 sends the previous file version number and the filename to the client layer 112; the client layer 112 sends the filename, the previous file version number, and the latest file version number of the file obtained from the file monitor list 114 to the versions control server 12.

In step S420, the versions control server 12 yields the previous file version according to the previous file version number and the latest file version number. The client layer 112 obtains the previous file version from the versions control server 12 and stores the previous file version in the temporary directory 113.

In step S422, the service layer 110 reads the previous file version into the object HttpResponse of HTTP protocol from the temporary directory 113. The client layer 12 removes the previous file version from the temporary directory 113 after the service layer 110 reads the previous file version, the procedure goes directly to step S416 described before.

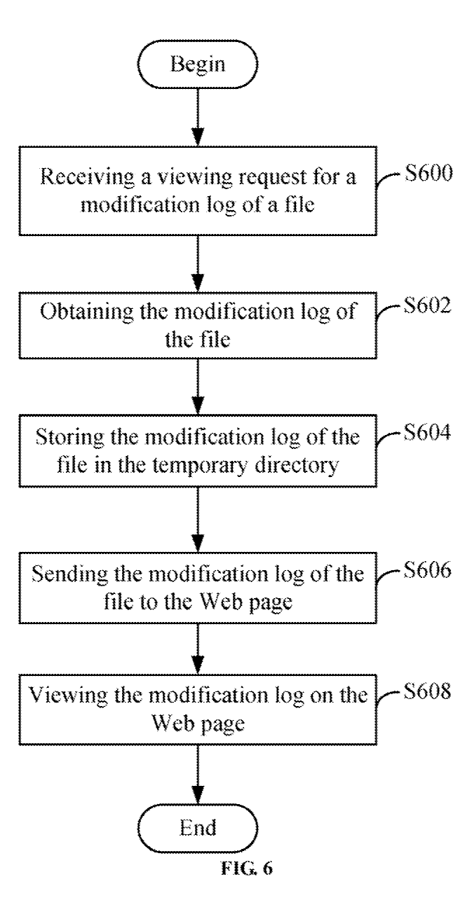

FIG. 6 is a flowchart of viewing a modification log of a file via an interface apparatus in accordance with a preferred embodiment. In step S600, the service layer 110 receives a viewing request for a modification log of the file from a user via the Web page 110 and sends the viewing request to the client layer 112. The viewing request includes a filename.

In step S602, the client layer 112 obtains the modification log of the file on the versions control server 12 according to the filename.

In step S604, the client layer 112 stores the modification log in the temporary directory 113.

In step S606, the service layer 110 sends the modification log to the Web page 10.

In step S608, the user views the modification log of the file on the Web page 10.

It is to be understood, however, that even though numerous characteristics and advantages of the indicated invention have been set forth in the foregoing description, together with details of the structure and function of the invention, the disclosure is illustrative only and changes may be made in details, especially in matters of shape, size and arrangement of parts within the principles of the invention to the full extent indicated by the broad general meaning of the terms in which the appended claims are expressed.

What is claimed is:

1. An interface apparatus for managing file versions of files, the interface apparatus being installed on a Web server and being connected with a versions control server which stores the files, wherein:
the interface apparatus is configured for receiving a request for a file via a Web page, the request being selective to be: an uploading request, a downloading request, or a viewing request;
the interface apparatus is further configured for managing the file, the managing being selective to be: uploading the file in the versions control server, downloading the file from the version control server, or downloading a modification log of the file from the versions control server to view.

2. The system of claim 1, the interface apparatus comprising: a service layer, a file control layer, and a client layer, wherein:
the file control layer is configured for creating a file monitor list in the Web server, the file monitor list listing all the files in the versions control server;
the file control layer is configured for creating a new entry for a new file in the file monitor list;
each of the files corresponds to an entry in the file monitor list and each entry in the file monitor list comprises: a filename field, a username field, a timestamp field, a version number field, and a status field shows if the file is “locked” or “unlocked”;
the client layer is connected with versions control server and is configured for creating a modification log for a new file in the versions control server;
the service layer is configured for receiving the uploading request, the downloading request for the file via the Web page and sending the request to the client layer; the uploading request comprises: the file, the username, brief change information; the file of the uploading request is the new file or a new file version; the downloading request comprises: the filename and a file access request; the file of the downloading request is a latest file version or a previous file version; the file access request is read only request or modify request;
the client layer is configured for storing the new file to the versions control server, storing the new file version to the versions control server if the file status is “unlocked” according to the status field, and modifying the status field to “unlocked;” the client layer is configured for downloading a previous file version from the versions control server, downloading a latest file version from the versions control server if the file status is “unlocked” according to the status field, and modifying the status field to “locked” if the latest file version is to be modified.

3. The system of claim 2, wherein:
the client layer is further configured for instructing the file control layer to updating the username field, the timestamp field and the version number field of the file in the file monitor list with the username, a timestamp, and the new file version number;
the client layer is further configured for inserting a new entry in the modification log, the new entry comprising: the new file version number field, the username field, and the timestamp field, and the brief change information field.

4. The system of claim 2, wherein:
the service layer is configured for reading the latest file version or the previous file version into the object HttpResponse of HTTP protocol if the client layer downloads the latest file version or the previous file version.

5. The system of claim 2, wherein:
the service layer is configured for receiving the viewing request and sending the viewing request to the client layer, the viewing request comprising a filename;
the client layer is configured for downloading the modification log of the file from the versions control server and sending the modification log to the service layer; the service layer is configured for sending the modification log to the Web page.

6. The system of claim 2, wherein the client layer is further configured for forbidding uploading the new file version if the file is “locked”.

7. The system of claim 2, wherein the modification log comprises a plurality of entries, and each entry corresponds to each modification of the file.

8. A method for managing file versions via an interface apparatus, the interface apparatus being installed on a Web server, the interface apparatus comprising a service layer, a file control layer, and a client layer, the interface apparatus being connected with a versions control server via the client layer, the method comprising:
submitting a request for a file via a Web page to the interface apparatus, the request being selective to be: an uploading request, a downloading request, and a viewing request;
managing the file via the interface apparatus, the managing being selective to be: uploading the file and the interface apparatus storing the file in the versions control server, the interface apparatus downloading the file from the version control server, or the interface apparatus downloading a modification log of the file from the versions control server to view.

9. The method of claim 8, wherein uploading the file and the interface apparatus storing the file in the version control server comprises:
receiving the uploading request for the file from the Web page, the uploading request comprising: a file, a username, and brief change information;
determining whether the uploading request is a new file request or a new file version request;
determining whether the file is being modified according to a status field of the file in a file monitor list if the uploading request is the new file version request, the status field showing if the file is “locked” or “unlocked”, the file being “unlocked” if the file is not being modified, the file being “locked” if the file is being modified;
forbidding uploading the new file version if the file is “locked”;
storing the new file version to the versions control server if the file is “unlocked”;
updating a username field, a timestamp field, and a version number field of the file in the file monitor list with the username, a timestamp, and the new file version number;
inserting a new entry to a modification log of the file, the new entry comprising the new file version number field, the username field, the timestamp field, and the brief change information field;
storing the new file to the versions control server, creating a new entry in the file monitor list for the new file, and creating a new modification log for the new file in the versions control server if the uploading request is the new file request;
modifying the status field of the file to “unlocked”.

10. The method of claim 9, wherein the interface apparatus downloading the file from the version control server comprises:
receiving the downloading request for the file via the Web page, the downloading request comprising: a filename and a file access request, the file access request comprising: read only request and modify request;
determining whether the downloading request is a latest file version request or a previous file version request;
determining whether the latest file version is to be modified according to the file access request if the latest file version is “unlocked” and modifying the status field to “locked” if the latest file version is to be modified;
obtaining the latest file version from the version control server according to the filename and the latest file version number;
reading the latest file version into the object HttpResponse of HTTP protocol;
obtaining the previous file version from the versions control server according to the filename, the latest version number, and the previous file version number and reading the previous file version into the object HttpResponse of HTTP protocol if the downloading request is the previous file version request;
saving the downloaded latest file version or the downloaded previous file version in the Web page.

11. The method of claim 9, wherein the interface apparatus downloading a modification log of the file from the versions control server to view comprises:
receiving a viewing request for the file via the Web page, the viewing request comprising a filename;
obtaining the modification log of the file on the versions control server according to the filename.
sending the modification log of the file to the Web page.
